(19) United States
(12) Patent Application Publication
(10) Pub. No.: US 2004/0021838 A1
(43) Pub. Date: Feb. 5, 2004

(54) Multi-image plastic film

(76) Inventor: Hsin-Chuan Wong, Taipei (TW)

Correspondence Address: SUPREME PATENT SERVICES, POST OFFICE BOX 2339, SARATOGA, CA, 95070, US

(21) Appl. No.: 10/211,717

(22) Filed: Aug. 1, 2002

(51) Int. Cl. G03B 27/32

(52) U.S. Cl. 355/22; 355/32; 348/96; 348/97; 430/138

(57) ABSTRACT

An image forming film includes a substrate having a non-light-absorbing surface. At least two light-transmitting layers each comprising a pattern, are stacked over each other and formed on the non-light-absorbing surface. A light-transmitting surface sheet is attached to the stack of the layers. The surface sheet has an outer surface on which a plurality of raised, substantially parallel strips are formed, each strip having a side face for directing light from the patterns of the layers toward different angles.

### FIELD OF THE INVENTION

The present invention relates generally to a film that shows images, and in particular to a film that shows dynamic or motive images.

### BACKGROUND OF THE INVENTION

Stereoscopic images are commonly formed by multiple printing techniques in which images of different field depths are printed one layer by one layer on a substrate. Another way for forming a stereoscopic image is holographic. Adding a transparent sheet to a printed film is another way to form a stereoscopic image. These conventional techniques, however, show only “static” images. In other words, the conventional techniques can show only one single image and the image that is displayed by the conventional techniques does not look motive. The image formed by the discussed conventional techniques is still.

It is thus desired to form a stereoscopic image that is motive.

### SUMMARY OF THE INVENTION

An object of the present invention is to provide an image forming film that shows a motive image.

Another object of the present invention is to provide an image forming film that is comprised of a number of images.

To achieve the above objects, in accordance with the present invention, there is provided an image forming film comprising a substrate having a non-light-absorbing surface. At least two light-transmitting layers each comprising a pattern, are stacked over each other and formed on the non-light-absorbing surface. A light-transmitting surface sheet is attached to the stack of the layers. The surface sheet has an outer surface on which a plurality of raised, substantially parallel strips are formed, each strip having a side face for directing light from the patterns of the layers toward different angles.

### BRIEF DESCRIPTION OF THE DRAWINGS

The present invention will be apparent to those skilled in the art by reading the following description of preferred embodiments thereof, with reference to the attached drawings, in which:

FIG. 1 is an exploded view of an image forming film constructed in accordance with the present invention;

FIG. 2 is a perspective view of the image forming film in accordance with the present invention;

FIG. 3 is a side elevational view showing an observer is observing the image forming film of the present invention;

FIG. 4 is an enlarged view of the encircled portion of FIG. 3;

FIGS. 5a-5e are similar to FIG. 4 but showing image forming films constructed in accordance with different embodiments of the present invention; and

FIG. 6 is a schematic view showing different images observed by the observer by viewing the image forming film at different angles.

### DETAILED DESCRIPTION OF THE INVENTION

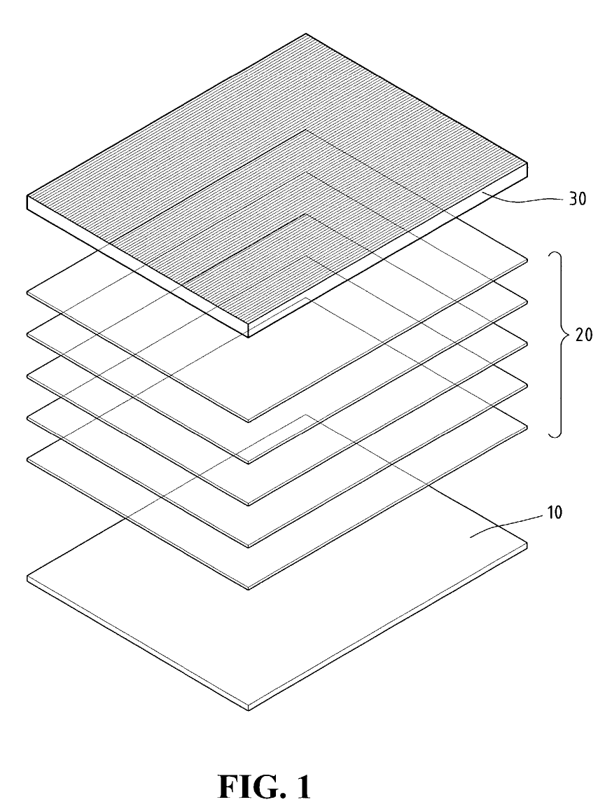

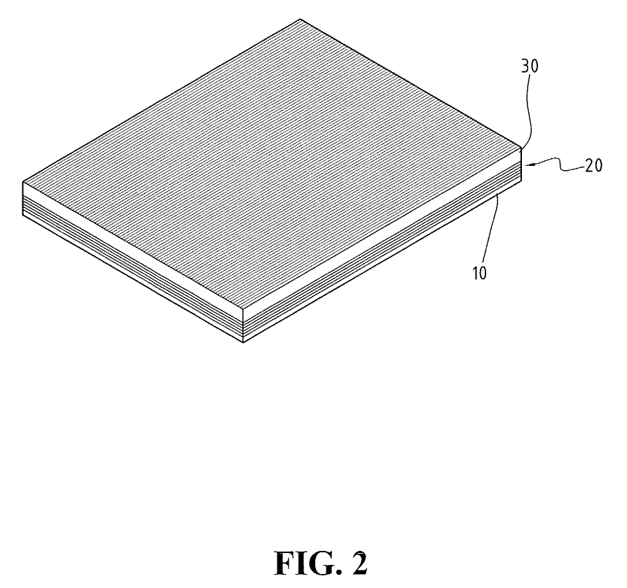

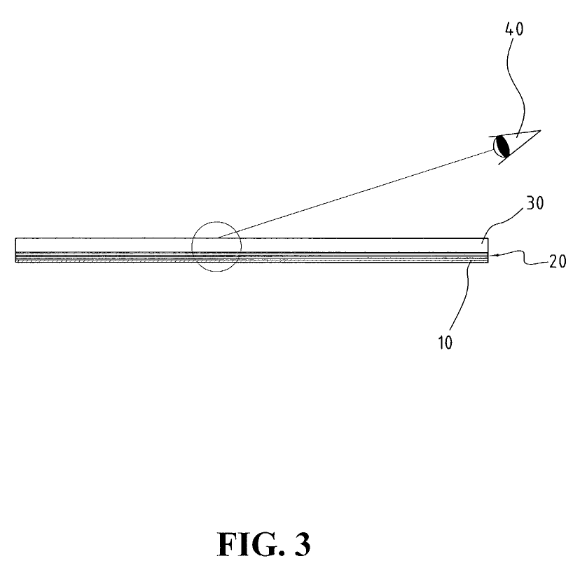

With reference to the drawings and in particular to FIGS. 1-3, an image forming film constructed in accordance with the present invention comprises a base layer or substrate 10 having a major surface (not labeled) on which a plurality of pattern-printed layers 20 are formed and a light-transmitting surface sheet 30 formed on the pattern-printed layers 20. In the embodiment illustrated, there are five pattern-printed layers 20 each carrying a different pattern but the present invention is equally applicable to an image forming film having two or more pattern-printed layers. The patterns (not shown) are printed on the pattern-printed layers 20. The patterns form images when an observer is observing the image forming film.

The substrate 10 is non-light-transmitting and the surface of the substrate 10 has a color of white or other bright colors whereby light is reflected by the major surface of the substrate 10. In other words, the substrate 10 has a major surface that does not substantially absorb light.

The pattern-printed layers 20 are made of light-transmitting or translucent materials and are stacked over each other whereby patterns printed on a lower one of the layers 20 can be observed by the observer by viewing through an upper one of the layers 20. As mentioned above, the patterns are formed by directly printing on the major surface of the substrate 10 or the lower next one of the pattern-printed layers 20. Alternatively, the patterns are printed on thin films and the thin films are attached to the lower next one by means of for example adhesive.

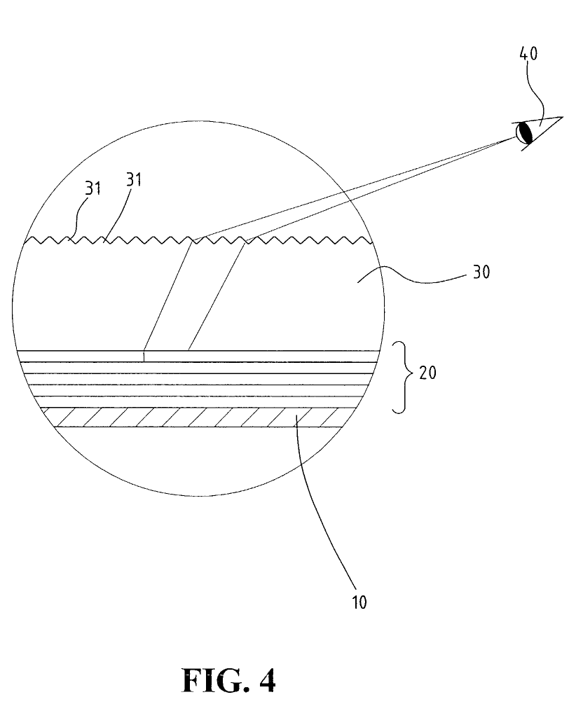

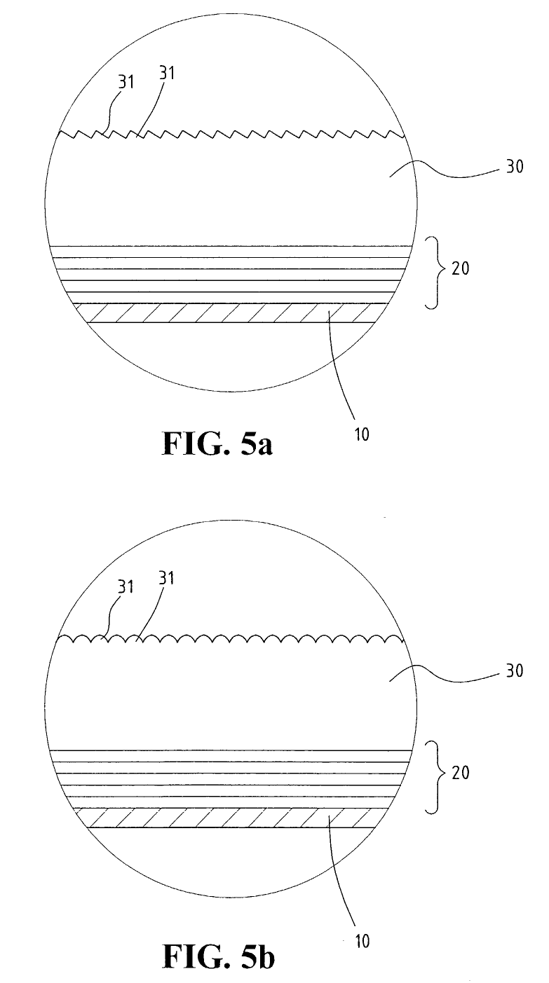

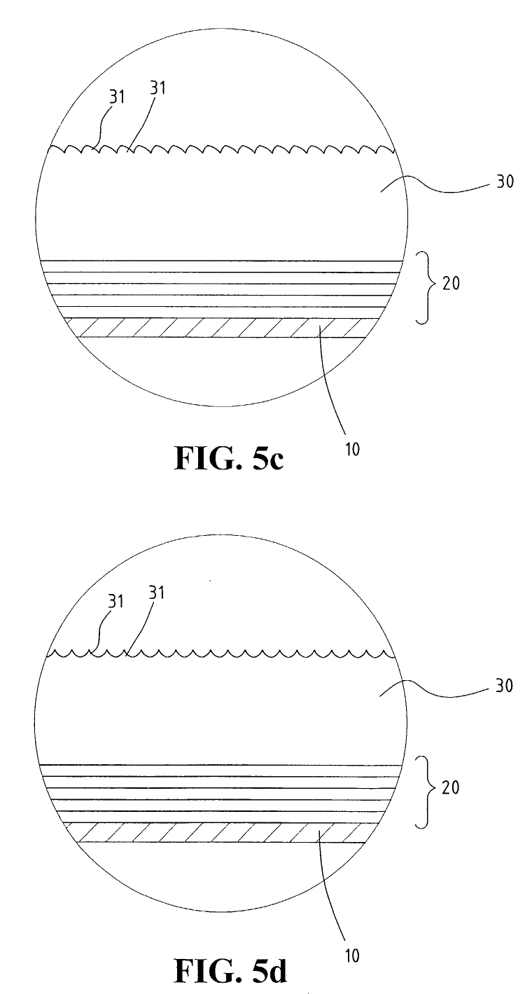

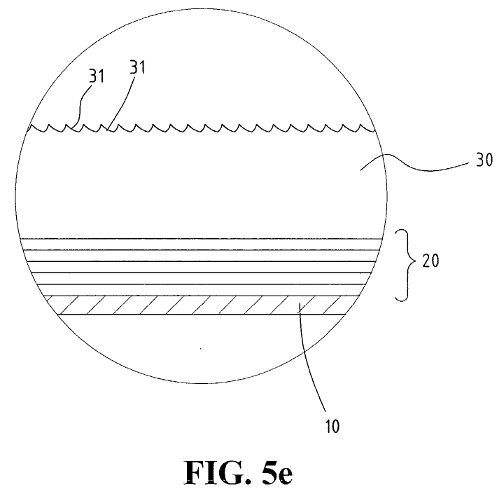

Also referring to FIG. 4, the surface sheet 30 is made of light-transmitting material, having an outer surface on which a plurality of raised strips 31 are formed. The strips 31 are substantially parallel to each other. Each strip 31 has two opposite side faces, which may be straight, or arc for directing, such as refracting, light. In the embodiment illustrated in FIG. 4, the strips 31 have an isosceles triangular cross section that has two symmetric straight side faces. In the embodiment illustrated in FIG. 5a, the strips 31 have a triangular cross section having non-symmetric straight side faces. In the embodiment illustrated in FIG. 5b, the strips 31 have a round cross section having symmetric convex side faces. In the embodiment illustrated in FIG. 5c, the strips 31 have a cross section that has non-symmetric convex side faces. In the embodiment illustrated in FIG. 5d, the strips 31 has a cross section that has symmetric concave side faces and in the embodiment illustrated in FIG. 5e, the strips 31 have a cross section that has non-symmetric concave side faces.

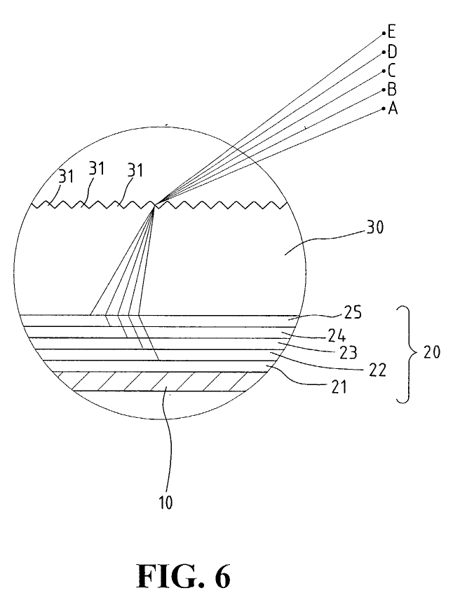

Also referring to FIG. 6, in observing the images formed by the patterns of the film in accordance with the present invention, an observer 40 puts his or her eyesight at an angle not zero degree with respect to the outer surface of the surface layer 30. In other words, the eyesight of the observer 40 is not parallel to the outer surface of the surface layer 30. Preferably, the eyesight of the observer 40 is substantially normal to the surface layer 30. Light from the patterns of each pattern-printed layers 20 is refracted by the side faces of the strips 31 at different angles whereby the observer can see different images from different pattern-printed layers 20.

As shown in FIG. 6 in which the pattern-printed layers, although collectively designated with reference numeral 20, have individual reference numerals 21-25, patterns printed on the pattern-printed layers 21-25 are refracted by the film and the side faces of the strips 31 at different angles as indicated by reference characters A-E whereby when the observer 40 is viewing at position A, the observer 40 sees the pattern of the pattern-printed layer 21 and when the observer 40 is viewing at position B, the observer sees the pattern of the pattern-printed layer 22 and so on.

In case that the patterns of the pattern-printed layers 21-25 form consecutive images, when the observer moves his or her eyesight from position A, through positions B-D in sequence, to position E, the observer can view a continuous motion of the image. Thus, the image is motive.

In case that the patterns of the pattern-printed layers 21-25 do not form consecutive images or are not related, then the observer can view different images when he or her is observing at different positions A-E. The number of the pattern-printed layers 21-25 is in general not limited. Thus, the film of the present invention can display a great number of images.

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. An image forming film comprising:
a substrate having a non-light-absorbing surface;
two light-transmitting layers each comprising a pattern, the layers being stacked over each other and formed on the non-light-absorbing surface; and
a light-transmitting surface sheet attached to the stack of the layers, the surface sheet having an outer surface on which a plurality of raised, substantially parallel strips are formed, each strip having a side face for directing light from the patterns of the layers toward different angles.

2. The image forming film as claimed in claim 1, wherein the substrate is made of a non-light-transmitting material.

3. The image forming film as claimed in claim 2, wherein the first surface of the substrate has a color that substantially reflects light.

4. The image forming film as claimed in claim 1, wherein the light-transmitting layers have a lower layer and an upper layer and wherein the lower layer is formed by directly printing on the first surface of the substrate and the upper layer is formed by directly printing on the lower layer.

5. The image forming film as claimed in claim 1, wherein the light-transmitting layers are comprised of thin films on which the patterns are printed, the thin films being adhered to the substrate.

6. The image forming film as claimed in claim 1, wherein the strips have an isosceles triangular cross section.

7. The image forming film as claimed in claim 1, wherein the strips have a triangular cross section that has non-symmetric side faces.

8. The image forming film as claimed in claim 1, wherein the strips have a round cross section that has non-symmetric convex side faces.

9. The image forming film as claimed in claim 1, wherein the strips have a round cross section that has symmetric convex side faces.

10. The image forming film as claimed in claim 1, wherein the strips have a cross section that has non-symmetric concave side faces.

11. The image forming film as claimed in claim 1, wherein the strips have a cross section that has symmetric concave side faces.

12. The image forming film as claimed in claim 1, wherein the image forming film comprises a number of light-transmitting layers comprising consecutive patterns that form a motive image when viewed consecutively.
